(19) United States
(12) Patent Application Publication
(10) Pub. No.: US 2012/0303463 A1
(43) Pub. Date: Nov. 29, 2012

(54) ADCACHE SPACE AUCTIONS BASED ON DIFFERENTIAL CONTEXT

(75) Inventors: Arthur Stephens, Hazlet, NJ (US); Ranjith S. Jayaram, Short Hills, NJ (US); Georgios Tsirtsis, London (GB); Vincent D. Park, Budd Lake, NJ (US); Zhibin Wu, Bedminster, NJ (US)

(73) Assignee: QUALCOMM Incorporated, San Diego, CA (US)

(21) Appl. No.: 13/116,855

(22) Filed: May 26, 2011

(51) Int. Cl. G06Q 30/00

(52) U.S. Cl. 705/14.71

(57) ABSTRACT

In some embodiments, in an exemplary advertising system multiple bidders compete for ad cache space on devices which display ads. The bidders are, e.g., advertisers, ad networks, and/or loyalty program providers. The devices which store and display the ads are, e.g., mobile and/or stationary wireless communications devices. An individual bidder is provided with contextual information that is of relevance to the individual bidder. The contextual information is about the device onto which ads may be loaded. Different bidders may be, and sometimes are, supplied with different restricted information. Various embodiments are directed to a methods and apparatus for operating an ad broker system.

### FIELD

Various embodiments relate to advertising, and more particularly, to methods and apparatus related to the auctioning of ad space in an ad cache.

### BACKGROUND

Advertising networks (“AdNetworks”) can be classified according to the parameters they use for targeting advertisements. An online mobile AdNetwork typically uses parameters such as user application, search keywords and user location to target ads. A loyalty-based AdNetwork, on the other hand, targets ads to a user based on knowledge of the user's unique ID and purchase history with the store the user is loyal to. Given a particular context on a device, ads from one type of ad network may be more relevant to the user than ads from another type of ad network. For example, if a user is interacting with a bookstore application, the bookstore's specialized ad network may be able to target ads better than a general-purpose online ad network. This is because the bookstore's ad network can make use of the user's book purchase history to learn about the user's interests and tailor ads accordingly; such history is usually not available to general-purpose AdNetworks.

In view of the above discussion, it should be appreciated that in order to maximize the ability of advertisers to target ads, it is desirable to provide them as much context information as possible. However, this is also counter balanced by the device user's desire to maintain some level of privacy and/or for advertisers not to have customer information, e.g., loyalty program information, shared with competitors.

Devices may retrieve ads from limited storage space on the device and display them. Thus, ad storage space on a device, like the display of an ad, may be considered an advertising resource since the more ads an advertiser or AdNetwork is able to load on a device the greater the chance that a device is likely to display one or more of the ads.

It would be desirable if companies could generate revenue from the right to load and store ads on communications devices where the ads by virtue of having been stored on the device have some probability of being displayed.

In view of the above discussion, it should be appreciated that there is a need for methods and/or apparatus for generating revenue, e.g., by allowing advertisers to bid for the right to store ads in an ad cache on one or more devices which may display the ads.

### SUMMARY

In some embodiments, in an exemplary advertising system multiple bidders compete for ad cache space on devices which display ads. The bidders are, e.g., advertisers, ad networks, and/or loyalty program providers. The devices which store and display the ads are, e.g., mobile and/or stationary wireless communications devices. An individual bidder is provided with contextual information that is of relevance to the individual bidder. The contextual information is about the device onto which ads may be loaded and/or about the user of the device onto which ads may be loaded. Different bidders may be, and sometimes are, supplied with different restricted information. Various embodiments are directed to a methods and apparatus for operating an ad broker system.

An exemplary method of operating an ad broker system, in accordance with some embodiments, comprises: receiving information relevant to ad targeting from at least one device, said device including an ad cache in which ad information may be stored; providing at least some of said received information to a plurality of competing bidders; and auctioning off storage space in said ad cache to said plurality of competing bidders. An exemplary ad broker device, in accordance with some embodiments, comprises at least one processor configured to: receive information relevant to ad targeting from at least one device, said device including an ad cache in which ad information may be stored; provide at least some of said received information to a plurality of competing bidders; and auction off storage space in said ad cache to said plurality of competing bidders. The exemplary ad broker device further comprises memory coupled to said at least one processor.

While various embodiments have been discussed in the summary above, it should be appreciated that not necessarily all embodiments include the same features and some of the features described above are not necessary but can be desirable in some embodiments. Numerous additional features, embodiments and benefits of various embodiments are discussed in the detailed description which follows.

### BRIEF DESCRIPTION OF THE FIGURES

FIG. 1 is a drawing of an exemplary advertising system in accordance with various exemplary embodiments.

FIG. 2 is a flowchart of an exemplary method of operating an ad broker system in accordance with an exemplary embodiment.

FIG. 3 is a drawing of an exemplary ad broker network device in accordance with an exemplary embodiment.

FIG. 4 is an assembly of modules which can, and in some embodiments is, used in the exemplary ad broker network device illustrated in FIG. 3.

FIG. 5 is a drawing of an exemplary advertising system in accordance with various exemplary embodiments.

FIG. 6 is a drawing illustrating exemplary bidders communicating bid preference information to an exemplary ad broker device in an exemplary advertising system in accordance with an exemplary embodiment.

FIG. 7 is a drawing illustrating an exemplary mobile wireless device, including ad cache space to be auctioned by the ad broker device of FIG. 6, which is communicating information relevant to ad targeting to the ad broker device in accordance with an exemplary embodiment.

FIG. 8 is a drawing illustrating the ad broker device of FIG. 6 providing public information and different restricted information to different potential bidders in accordance with an exemplary embodiment.

FIG. 9 is a drawing illustrating different competing bidders submitting bids to the ad broker device of FIG. 6 in accordance with an exemplary embodiment.

FIG. 10 is a drawing illustrating the ad broker device of FIG. 6 communicating winning bid information in accordance with an exemplary embodiment.

FIG. 11 is a drawing illustrating winning bidders communicating ad information to fill the ad space in the mobile device cache which has been won in the auction in accordance with an exemplary embodiment.

FIG. 12 is a drawing illustrating an exemplary mobile device selecting between stored ads in its ad cache in accordance with an exemplary embodiment.

### DETAILED DESCRIPTION

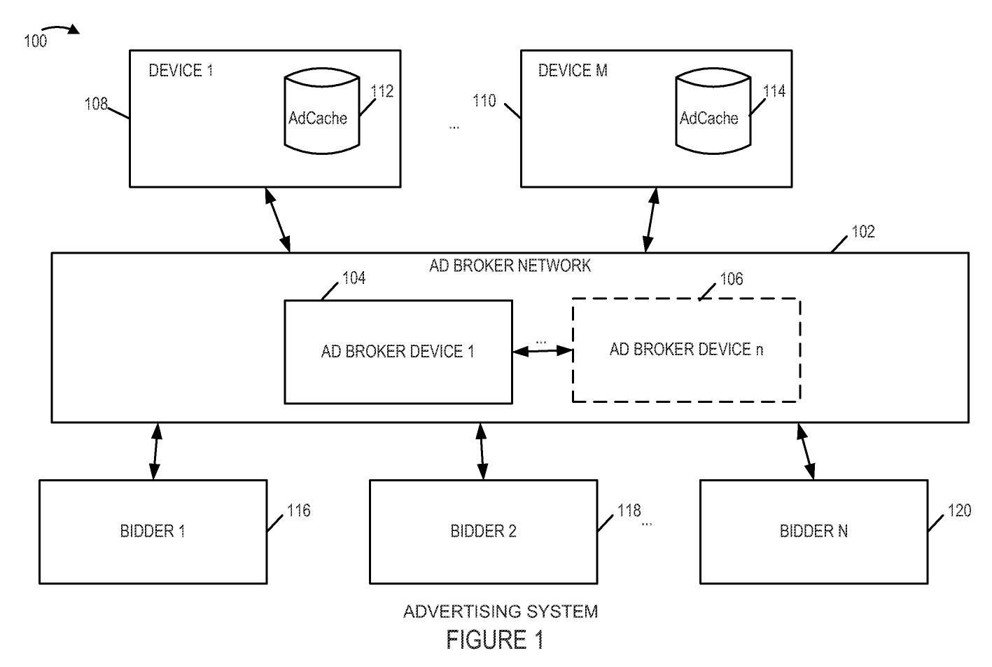

FIG. 1 is a drawing of an exemplary advertising system 100 in accordance with various exemplary embodiments. Exemplary advertising system 100 includes a plurality of devices (device 1 108, . . . , device M 110) including ad caches (ad cache 112, . . . , ad cache 114), respectively, coupled to ad broker network 102. In some embodiments, at least some of the devices (108, . . . , 110) are mobile wireless devices. The advertising system 100 also includes a plurality of bidder devices (bidder 1 116, bidder 2 118, . . . , bidder N 120) coupled to the ad broker network 102. Ad broker network 102 includes ad broker device 1 104, and, in some embodiments, one or more additional ad broker devices, e.g., ad broker network device n 106. The ad broker network 102 auctions off storage space in ad caches (ad cache 110, . . . , ad cache 114) of devices (device 1 108, . . . , device M 110), respectively. The ad broker network 102 receives information relevant to targeting ads from the devices (108, . . . , 110). Some of the information received may be public information while other information received may be restricted information. The ad broker network 102 provides at least some of the received information to at least some of the competing bidders (116, 118, . . . , 120), e.g., with different sets of information being provided to different bidders, in at least some embodiments. The bidders (116, 118, . . . , 120), which desire to place bids for the ad cache space being auctioned off, provide bids for the ad cache space being auctioned to the ad broker network 102. The ad broker network 102 processes the received bids and determines a winning bidder which is notified.

In some embodiments, a single ad broker network device, e.g., ad broker device 1 104, performs multiple or all of the functions of the ad broker network 102. In some embodiments, different ad broker devices (104, . . . , 106) within the ad broker network 102 perform different functions. For example, one ad broker device may receive and process information relevant to ad targeting; another ad broker device may determine which received information to provide to which bidders; another ad broker device may interface with the bidders, e.g., providing determined ad target information, receiving bids, and notifying the winning bidder. Another ad broker device may process received bids and determine a winning bidder, and still another ad broker device may perform accounting information related to the billing and/or payment of winning bids. Still another ad broker network device may receive ad information from a winning bidder and communicate it to the device including the ad cache corresponding to the winning bid.

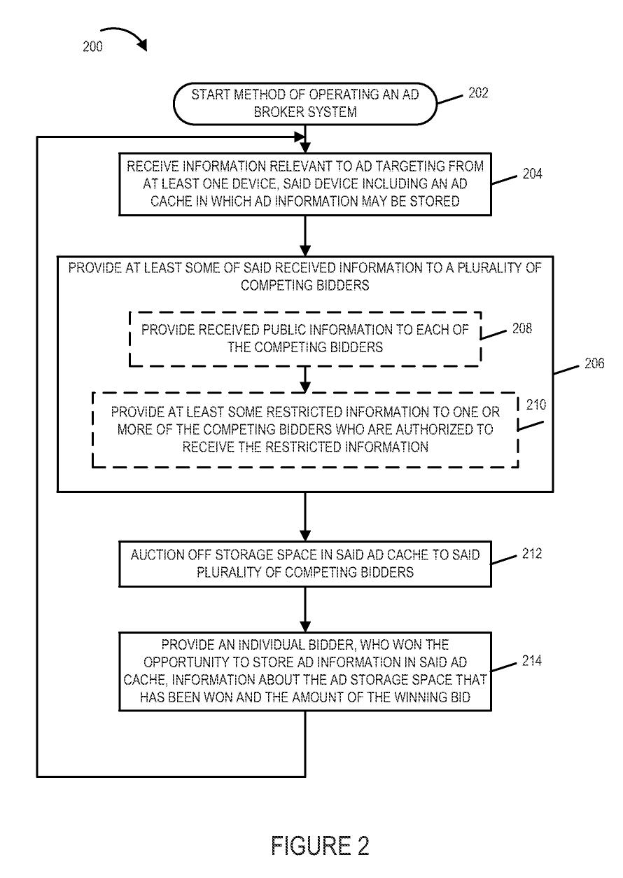

FIG. 2 is a flowchart 200 of an exemplary method of operating an ad broker system in accordance with an exemplary embodiment. In some embodiments, the steps of flowchart 200 are performed by an ad broker network, e.g., ad broker network 102 of advertising system 100 of FIG. 1. In some such embodiments, the steps of flowchart 200 are performed by an ad broker network device included within the ad broker network. Operation of the exemplary method starts in step 202, where the ad broker system is powered on and initialized. Operation proceeds from start step 202 to step 204.

In step 204, information is received relevant to ad targeting from at least one device including an ad cache in which ad information may be stored. In some embodiments, the information received from an individual device may, and sometimes does, include at least some public information and some restricted information. Operation proceeds from step 204 to step 206.

In step 206, at least some of said received information is provided to a plurality of competing bidders. In various embodiments, the competing bidders include at least one of: advertisers, ad networks, or loyalty program providers. In some embodiments, the different advertisers correspond to different store chains. In some embodiments, the competing bidders are different ad networks, and each ad network is a source of advertisements which may be presented.

In some embodiments, step 206 includes steps 208 and 210. In step 208, received public information is provided to each of the competing bidders, and in step 210 at least some restricted information is provided to one or more of the competing bidders who are authorized to receive the restricted information.

In some embodiments, different competing bidders receive different subsets of the restricted information based on their different rights to access the restricted information. In some embodiments, individual competing bidders are provided with restricted information corresponding to loyalty programs which they administer but not to loyalty programs which they do not administer. For example, an individual competing bidder is not provided with loyalty program information about programs which are administered by a competitor. In one example, a user of a device is a member of a loyalty program being administered by a particular bidder, and information about the ads the loyalty program has on the device or has previously had on the device and how the ads performed is provided to the particular bidder, e.g., statistics indicating past ad performance on the device. Different bidders corresponding to different administered loyalty programs may also get information on past ad performance relating to their previous ads on the device.

In some embodiments, the restricted information includes at least some personal user information and providing of said restricted information to bidders is controlled as a function of user specified information sharing restrictions.

Operation proceeds from step 206 to step 212. In step 212 storage space in said ad cache is auctioned off to said plurality of competing bidders. Operation proceeds from step 212 to step 214. In step 214 an individual bidder, who won the opportunity to store ad information in said ad cache, is provided information about the ad storage space that has been won and the amount of the winning bid. In some embodiments, the winning bid information may be, and sometimes is, provided to others as well. For example, in some such embodiments, the winning bid is listed on a public listing.

In some embodiments, the ad broker network device receives user specified information sharing restrictions, e.g., from a device including an ad cache, prior to providing information to a plurality of competing bidders. In some embodiments, the ad broker network device receives bidder preference information, e.g., from a potential bidder or bidders, and the ad broker network device selects a set of potential bidders to contact regarding an auction as a function of the received bidder preference information. For example, potential exemplary bidder A may request that it be contacted when any devices within a predetermined set of devices have ad cache space to be auctioned off or when any devices belonging to a loyalty program which it administers have ad cache space to be auctioned off. The selected set of bidders may be the plurality of competing bidders to which information is provided in step 206 by the ad broker network device.

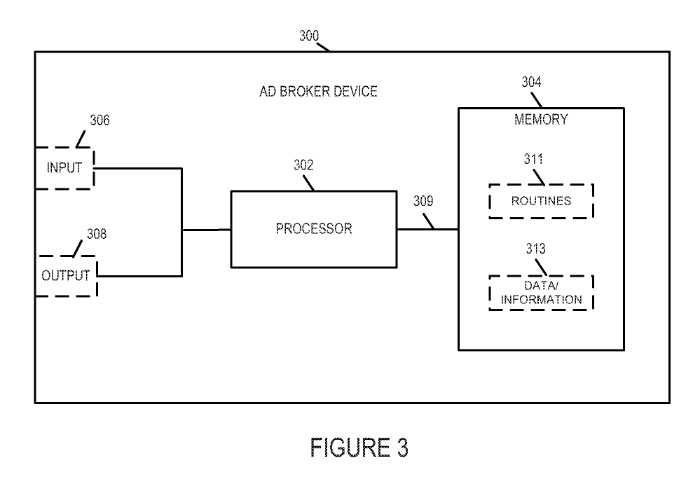

FIG. 3 is a drawing of an exemplary ad broker device 300 in accordance with an exemplary embodiment. Exemplary ad broker device 300 is, e.g., ad broker device 1 104 of advertising system 100 of FIG. 1. Exemplary ad broker device 300 may, and sometimes does, implement a method in accordance with flowchart 200 of FIG. 2.

Ad broker device 300 includes a processor 302 and memory 304 coupled together via a bus 309 over which the various elements (302, 304) may interchange data and information. Ad broker device 300 further includes an input module 306 and an output module 308 which may be coupled to processor 302 as shown. However, in some embodiments, the input module 306 and output module 308 are located internal to the processor 302. Input module 306 can receive input signals. Input module 306 can, and in some embodiments does, include a wireless receiver and/or a wired or optical input interface for receiving input. Output module 308 may include, and in some embodiments does include, a wireless transmitter and/or a wired or optical output interface for transmitting output. In some embodiments, memory 304 includes routines 311 and data/information 313.

In various embodiments, processor 302 is configured to receive information relevant to ad targeting from at least one device, said device including an ad cache in which ad information may be stored; provide at least some of said received information to a plurality of competing bidders; and auction off storage space in said ad cache to said plurality of competing bidders. In some such embodiments, said competing bidders include at least one of: advertisers, ad networks, or loyalty program providers. In some embodiments, processor 302 is further configured to: provide an individual bidder, who won the opportunity to store ad information in said ad cache, information about the amount of ad storage space that has been won and the amount of the winning bid.

In some embodiments, information received from an individual device including an ad cache, may and sometimes does, includes at least some public information and some restricted information. Processor 302, in various embodiments is configured to:

provide the received public information to each of the competing bidders; and provide at least some restricted information to one or more of the competing bidders who are authorized to receive the restricted information, as part of being configured to provide at least some received information to a plurality of competing bidders.

In various embodiments, different competing bidders receive different subsets of the restricted information based on their different rights to access restricted information. In some embodiments, processor 302 is configured to determine a subset of restricted information to provide to a competing bidder based on the rights to access restricted information. In some such embodiments, processor 302 is configured to generate different subsets of restricted information to provide to different bidders based on the different bidders' rights to access restricted information. Processor 302, in some such embodiments, if further configured to provide the generated different subsets of restricted information to the corresponding different bidders.

In some embodiments, processor 302 is configured to identify loyalty programs that an individual competing bidder administers. Processor 302, in various embodiments, is configured to provide individual competing bidders with restricted information corresponding to loyalty programs they administer but not loyalty programs which they do not administer.

In some embodiments, the restricted information includes at least some personal user information and processor 302 is configured to control providing of said restricted information to bidders as a function of user specified information sharing restrictions.

Processor 302, in some embodiments, is configured to provide information about ads belonging to a store in an ad cache only to the corresponding store's advertiser.

In some embodiments, competing bidders are different ad networks, and each ad network is a source of advertisements which may be presented. In some embodiments, different advertisers correspond to different store chains. In some embodiments, processor 302 is configured to identify the different store chains corresponding to a bidder. In some embodiments, processor 302 is configured to select a set of potential bidders for an auction. In some embodiments, processor 302 is configured to receive user specified information sharing restriction. In various embodiments, processor 302 is configured to receive bidder preference information. In some such embodiments, processor 302 is configured to select a set of potential bidders to contact for an auction as a function of received bidder preference information.

In various embodiments, processor 302 is configured to post winning bid information on a public listings. In some embodiments, processor 302 is configured to select multiple winning bidders corresponding to at least some auctions. In some such embodiments, processor 302 is configured to apportion the winning ad space in the ad cache among the winning bidders, e.g., as a function of predetermined percentages. In some embodiments, processor 302 is configured to apportion the winning ad space in the ad cache among the winning bidders, e.g., as a function of the difference between the bidding bids.

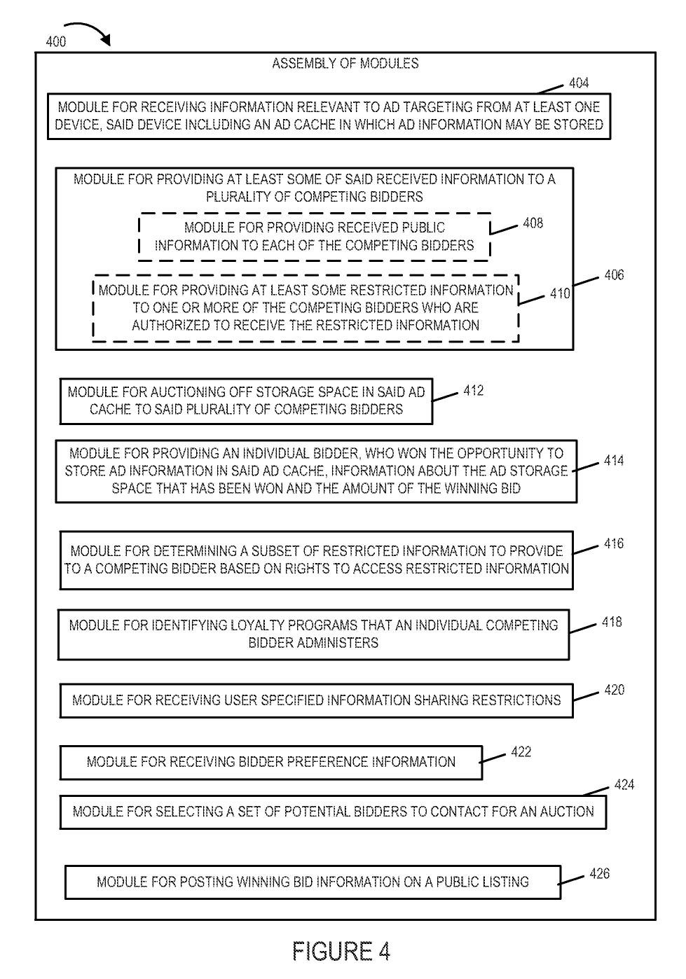

FIG. 4 is an assembly of modules 400 which can, and in some embodiments is, used in the exemplary ad broker device 300 illustrated in FIG. 3. The modules in the assembly 400 can be implemented in hardware within the processor 302 of FIG. 3, e.g., as individual circuits. Alternatively, the modules may be implemented in software and stored in the memory 304 of ad broker device 300 shown in FIG. 3. In some such embodiments, the assembly of modules 400 is included in routines 311 of memory 304 of ad broker device 300 of FIG. 3. While shown in the FIG. 3 embodiment as a single processor, e.g., computer, it should be appreciated that the processor 302 may be implemented as one or more processors, e.g., computers. When implemented in software the modules include code, which when executed by the processor, configure the processor, e.g., computer, 302 to implement the function corresponding to the module. In some embodiments, processor 302 is configured to implement each of the modules of the assembly of modules 400. In embodiments where the assembly of modules 400 is stored in the memory 304, the memory 304 is a computer program product comprising a computer readable medium, e.g., a non-transitory computer readable medium, comprising code, e.g., individual code for each module, for causing at least one computer, e.g., processor 302, to implement the functions to which the modules correspond.

Completely hardware based or completely software based modules may be used. However, it should be appreciated that any combination of software and hardware (e.g., circuit implemented) modules may be used to implement the functions. As should be appreciated, the modules illustrated in FIG. 4 control and/or configure the ad broker device 300 or elements therein such as the processor 302, to perform the functions of the corresponding steps illustrated and/or described in the method of flowchart 200 of FIG. 2.

Assembly of modules 400 includes a module 404 for receiving information relevant to ad targeting from at least one device, said device including an ad cache in which ad information may be stored. In various embodiments, during at least some times, the information received from an individual device includes at least some public information and some restricted information. Assembly of modules 400 further includes a module 406 for providing at least some of said received information to a plurality of competing bidders, a module 412 for auctioning off storage space in said ad cache to said plurality of competing bidders, and a module 414 for providing an individual bidder, who won the opportunity to store ad information in said ad cache, information about ad storage space that has been won and the amount of the winning bid. Module 406 includes a module 408 for providing received public information to each of the competing bidders and a module 410 for providing at least some restricted information to one or more of the competing bidders who are authorized to receive the restricted information.

In various embodiments, the competing bidders include at least one of: advertisers, ad networks, or loyalty program providers. In various embodiments, the competing bidders are different ad networks, and each ad network is a source of advertisements which may be presented. In some embodiments, different advertisers correspond to different store chains.

Assembly of modules 400 further includes a module 416 for determining a subset of restricted information to provide to a competing bidder based on rights to access restricted information, a module 418 for identifying loyalty programs that an individual competing bidder administers, a module 420 for receiving user specified information sharing restrictions, a module 422 for receiving bidder preference information, a module 424 for selecting a set of potential bidders to contact for an auction and a module 426 for posting winning bid information of a public listing. In some embodiments, different competing bidders receive different subsets of the restricted information based on their different rights to access restricted information, e.g., module 416 determines different subsets of restricted information for different competing bidders and module 410 provides the determined different subsets of restricted information to the different competing bidders.

In some embodiments, individual competing bidders are provided with restricted information corresponding to loyalty programs which they administer but not to loyalty programs which they do not administer. For example, module 418 identifies the loyalty programs a bidder administers, and module 416 determines a subset of restricted information for the bidder as a function of the identified loyalty programs, and then module 410 provides the determined subset of restricted information to the bidder. In some embodiments, the provided restricted information corresponding to a loyalty program includes information about ads a loyalty program has on or has had on a device for which ad space bidding is taking place and/or information about how the ads have performed, e.g., information indicating past ad performance on the device.

In some embodiments, the restricted information received, e.g., via module 404 from a device may, and sometimes does, include at least some personal information, and providing of restricted information to bidders, e.g., via module 410, is controlled as a function of user specified information sharing restrictions.

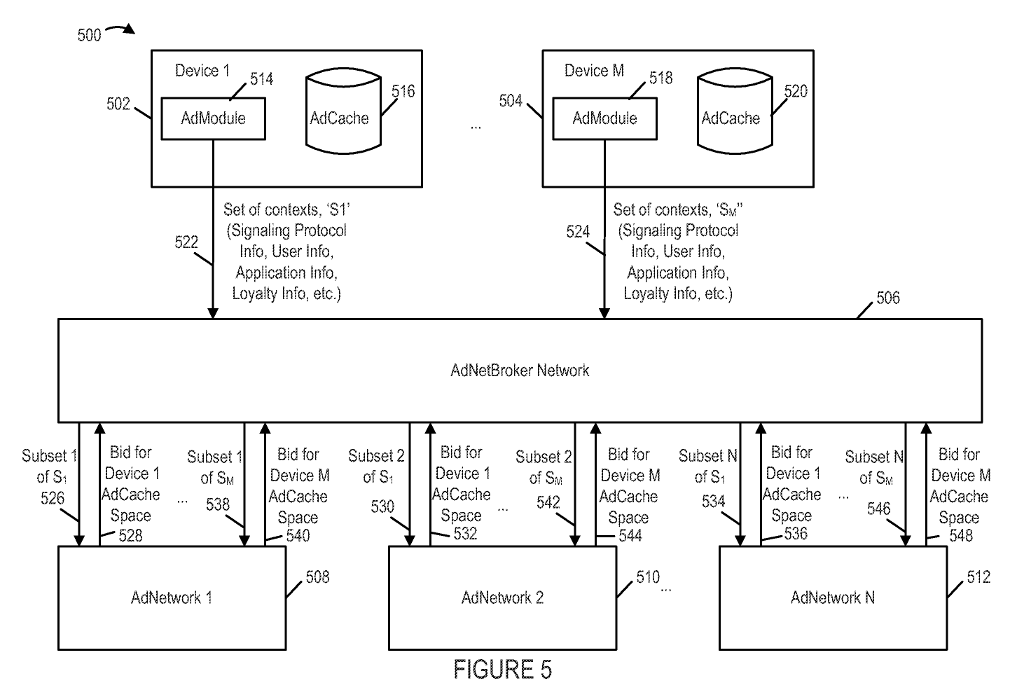

In some embodiments, an exemplary advertising system, e.g., exemplary system 500 of FIG. 5, includes multiple ad networks, sometimes referred to as “AdNetworks” (Ad Network 1 508, AdNetwork 2 510, . . . , AdNetwork N 512) which may, and sometimes do, compete for the right to load ads and/or other data used to retrieve ads into devices which display ads (device 1 502, . . . , device M 504). An individual AdNetwork receives contextual information, that is of relevance to the individual AdNetwork. The contextual information is about user devices onto which ads may be loaded. Different AdNetworks may be, and sometimes are, supplied with different information for privacy reasons and/or because some information such as loyalty program information may be considered information corresponding to another AdNetwork. Since different AdNetworks which may compete for ad storage space on devices may receive different information, the ad networks are confronted with “differential context”, i.e., different context information depending on the identity of the particular AdNetwork and the participants, e.g., stores, in the AdNetwork. The AdNetworks compete to provide ads to devices based on the differential context information that they receive.

Consider exemplary system in which a device has a cache, e.g., an “AdCache”, that includes metadata for ads. In exemplary system 500 devices (device 1 502, . . . , device M 504) include ad caches (AdCache 516, . . . , AdCache 520), respectively. At a presentation opportunity, the device runs an ad selection method which chooses a subset of ads to be presented at the opportunity. A typical selection method is an auction where the ads that have the highest bids are selected for presentation. For example in device 1 502, at a presentation opportunity, ad module 514 implements a method including a auction which chooses a subset of ads included within AdCache 516 to be presented. Similarly, in device M 504, at a presentation opportunity, ad module 518 implements a method including an auction which chooses a subset of ads included within AdCache 520 to be presented.

In some embodiments, an AdCache is owned and/or managed by an entity, e.g. an entity called the “AdNetBroker”. The AdNetBroker's objective is to fill the AdCache with ads from multiple AdNetworks. To achieve this goal, the AdNetBroker holds an auction for portions of the AdCache space of the devices that it owns and/or manages. Alternately, the AdNetBroker may auction off AdCache space on a group of devices, e.g., “AdCache space on 1000 AdCaches with a certain set of characteristics”. In the example of FIG. 5, the ad caches (AdCache 516, . . . , AdCache 520) are owned and/or managed by AdNetBroker Network 506. In some embodiments, AdNetBroker Network 506 is a single device. In other embodiments, AdNetBroker network 506 includes a plurality of devices coupled together, e.g., with different devices implementing different functions.

Prior to the auction for ad space on an ad cache, an “AdModule” on a device sends the AdNetBroker's network a variety of information about the device and the user. For example, if ad space on AdCache 516 of device 502 is being auctioned off, then ad module 514 sends ADNetBroker network 506 information 522. Similarly, if ad space on AdCache 520 of device 504 is being auctioned off, then ad module 518 sends AdNetBroker network 506 information 524. The communicated information includes information of two types:
1. “Public” information that is available to each of the AdNetworks participating in the auction. For example, the set of discovery information/expressions heard by a device.
2. Private information, sometimes also referred to as restricted information, that is to be made available to a subset of AdNetworks participating in the auction. For example, information about a user's loyalty card, in some embodiments, is to be disclosed to the corresponding loyalty ad network and not to other AdNetworks, e.g., because the user consented to disclose such information only to the loyalty card provider.

As shown in FIG. 5, the AdNetBroker network 506 forwards information about an AdCache to the AdNetworks (508, 510, . . . , 512) participating in the auction. In general, different AdNetworks (508, 510, . . . , 512) receive different pieces of information depending on what information they are authorized to receive, i.e., the auction is said to be based on differential context. This is unlike traditional online auctioning systems where the auctioneer provides the same set of information to all bidders.

For example, device 1 502 has communicated a set of contexts ‘S1’ to AdNetBroker network 506, and entity 506 selectively forwards information (subset 1 of S1 526, subset 2 of S1 530, . . . , subset N of S1 534) to ad networks (AdNetwork 1 508, AdNetwork 2 510, . . . , AdNetwork N 512), respectively. Similarly, device M 504 has communicated a set of contexts ‘S_{M}’ to AdNetBroker network 506, and entity 506 selectively forwards information (subset 1 of S_{M} 538, subset 2 of S_{M} 542, . . . , subset N of S_{M} 536) to ad networks (AdNetwork 1 508, AdNetwork 2 510, . . . , AdNetwork N 512), respectively.

The use of differential context raises questions about fairness of these auctions. One way to look at fairness is by considering what disclosures the user has implicitly or explicitly consented to. For example, if the user has signed up with loyalty provider X, it would be unfair to disclose that information to loyalty provider Y because the user would have consented only to disclose the membership information to X and not to Y. That is, equal disclosure of context would be unfair. So, according to this perspective, as long as differential context disclosures conform to rules based on user consent, the auction can be considered fair.

An AdNetwork, in some embodiments, may also request the AdNetBroker network to be notified when AdCaches of devices with certain types of contexts come up for auction. If the AdNetwork is authorized to receive the requested context information, the AdNetBroker honors the request and forwards the requested information to the AdNetwork at the time of the auction.

In addition, in some embodiments, the participating AdNetworks are provided details about the auction. Examples of this information include the amount of AdCache space being auctioned; duration for which the AdCache space will be available to winners of the auction; and the number of devices whose space is being auctioned.

An ad network, wishing to bid, places a bid for the space(s) being auctioned. In this example, ad networks (AdNetwork 1 508, AdNetwork 2 510 and AdNetwork N 512) wish to bid for the space being auctioned off on AdCache 516 and place bids (528, 532, 536), respectively, for device 1 ad cache space. In this example, ad networks (508, 510 and 512) also wish to bid for the space being auctioned off on AdCache 520 and place bids (540, 544, 548), respectivley, for device M ad cache space.

The AdNetBroker 506 chooses a subset of the highest bidders for each auction and allocates the auctioned AdCache space(s) among them. Various allocation methods may be, and sometimes are, used, e.g., depending upon the particular embodiment. For example, in one exemplary embodiment, the AdNetBroker, picks a predetermined number of top bidders, e.g., the top ten bidders, and allocates AdCache space in the ratio of their bids. In another exemplary embodiment, the AdNetBroker picks a predetermined number of top bidders, e.g., the top four bidders, and allocate them predetermined different size portions of the ad cache space that they have bid on, e.g., 40%, 30%, 20% and 10% of the AdCache space that they bid on. In some embodiments, the AdNetBroker may, and sometimes does, hold multiple auctions for different portions of the AdCache space within the same cache in the same device, e.g., with a single winner corresponding to each ad cache portion which was auctioned off. For example, AdNetBroker 506 may decide to auction off two portions of AdCache 516 and hold two separate auctions, and there is a single winner corresponding to each auction.

At the end of the auction, the AdNetBroker network announces information about the winning AdNetworks and their allocations to the devices affected by the auction and the bid-winning AdNetwork communicates an ad or information identifying an ad to be stored in the ad cache portion that it has won to the device(s). In some embodiments, a bid-winning AdNetwork communicates an ad to be stored in the ad cache portion that it has won via AdNetBroker Network. In some embodiments, a bid-winning AdNetwork communicates information identifying an ad to be stored in the ad cache portion that it has won via AdNetBroker Network. In some embodiments, a bid-winning AdNetwork communicates an ad to be stored in the ad cache portion that it has won via a signaling route that does not include the AdNetBroker Network. In some embodiments, a bid-winning AdNetwork communicates information identifying an ad to be stored in the ad cache portion that it has won via a signaling route that does not include the AdNetBroker Network.

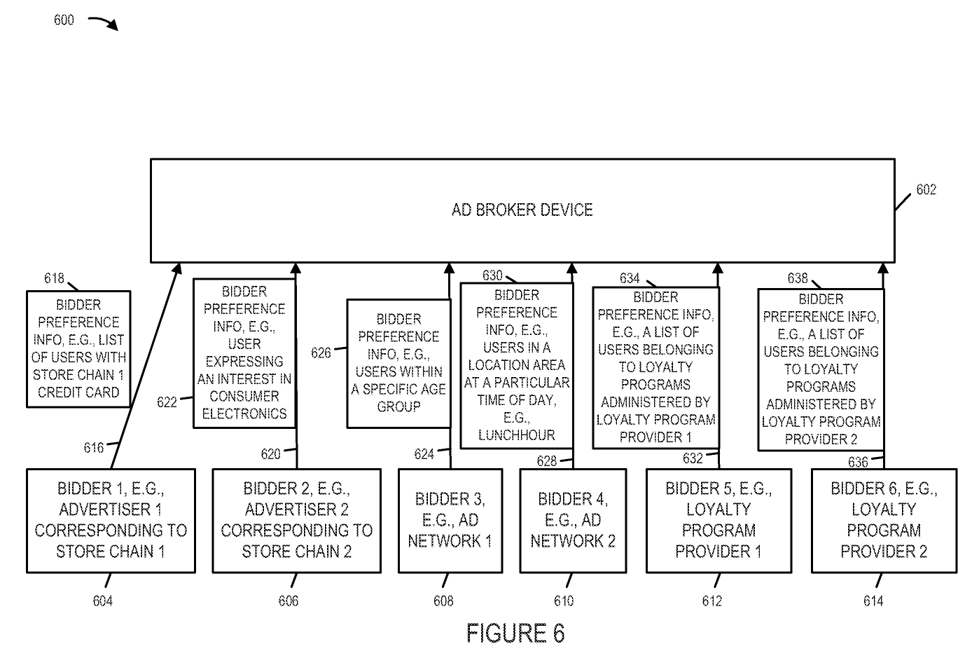

FIG. 6-12 illustrate an example in which an exemplary ad broker device implements an exemplary method of operating an ad broker system in which a plurality of bidders bid on ad cache space in a device, e.g., ad cache space in a mobile wireless device. The exemplary advertising system includes ad broker device 602 and a plurality of potential bidder devices (bidder 1 604, e.g., advertiser 1 corresponding to store chain 1, bidder 2 606, e.g., advertiser 2 corresponding to store chain 2, bidder 3 608, e.g., ad network 1, bidder 4 610, e.g., ad network 2, bidder 5 612, e.g., loyalty program provider 1, bidder 6 614, e.g., loyalty program provider 2). In drawing 600 of FIG. 6, each of the potential bidders (604, 606, 608, 610, 612, 614) send signals to the ad broker device 602 including bidder preference information. Bidder 1 604 sends signals 616 to ad broker device 602 including bidder preference information 618, e.g., a list of users with a store chain 1 credit card. Bidder 2 606 sends signals 620 to ad broker device 602 including bidder preference information 622, e.g., users expressing an interest in consumer electronics. Bidder 3 608 sends signals 624 to ad broker device 602 including bidder preference information 626, e.g., users within a specific age group. Bidder 4 610 sends signals 628 to ad broker device 602 including bidder preference information 630, e.g., users in a specified location area at a particular time of day, e.g., during lunch hour. Bidder 5 612 sends signals 632 to ad broker device 602 including bidder preference information 634, e.g., a list of users belonging to loyalty programs administered by loyalty program provider 1. Bidder 6 614 sends signals 636 to ad broker device 602 including bidder preference information 638, e.g., a list of users belonging to loyalty programs administered by loyalty program provider 2.

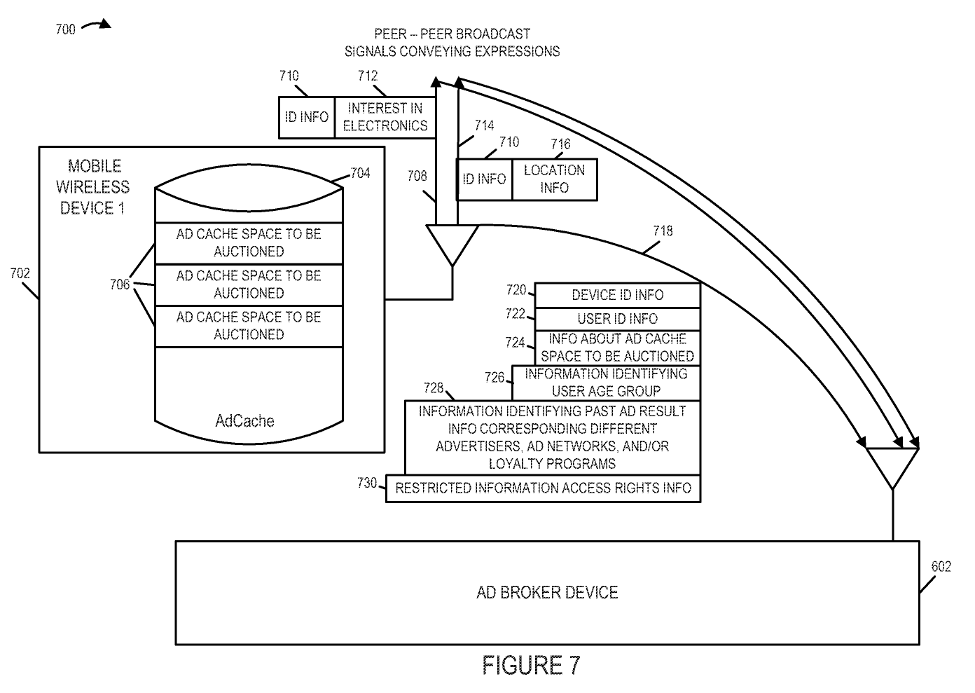

The exemplary advertising system further includes a plurality of devices including ad cache space which may be and sometimes is auctioned off by ad broker device 602. Drawing 700 of FIG. 7 illustrates exemplary mobile wireless device 1 702 including ad cache 704. Ad cache 704 includes currently available ad cache space 706 to be auctioned off by ad broker device 602. In this example, ad cache space to be auctioned 706 includes three equal size blocks in which ad information may be stored. Exemplary mobile wireless device 702 supports a peer to peer signaling protocol in which peer to peer broadcast signals conveying expressions carrying relatively small amounts of information may be, and sometimes are, transmitted by a device. In this example, mobile device 702 broadcasts peer to peer signal 708 conveying identification information 710 corresponding to device 702 and/or the user of device 702 and information identifying the device 702 and/or the user of device 702 has an interest in electronics, e.g., intends to go shopping for consumer electronic devices. In this example, mobile device 702 also broadcasts peer to peer signal 714 conveying identification information 710 corresponding to device 702 and/or the user of device 702 and information 716 identifying the location of device 702. The broadcast peer to peer signals (708, 714) are received by ad broker device 602 and the information conveying is recovered.

Device 702 also transmits signals 718 conveying information relating to auction of the ad cache space 706 to ad broker device 602 which receives and processes the information. In this example, signals 718 include device identification information 720, user identification information 722, information about the ad cache space to be auctioned 724, e.g., size of space, number of blocks, duration of time ads are to remain in the ad cache space, etc., information identifying the users age group 726 and/or other user demographic type information, information identifying past ad result information corresponding to different advertisers, ad networks, and/or ad loyalty programs, and restricted information access rights information 730.

Ad broker device 602 selects a set of bidders to provide information relevant to the auction of the ad cache space 706 in mobile device 702. In this example, bidder 1 604 is selected because the use of device 1 has been identified as owning a store chain 1 credit card; bidder 2 606 is selected because device 2 has expressed an interest in consumer electronics and is a likely candidate to purchase from store chain 2. Bidder 3 608 is rejected because the age group of the user of device 702 does not fall into the category that ad network 1 is looking for. Bidder 4 610 is selected because the current time is during the lunch hour and device 1 702 is in the predetermined area of interest, e.g., near a mall including a food court in which ad network 2 has a client. Bidder 5 612 is selected because the user of device 702 belongs to a loyalty program administered by loyalty program provider 1; and bidder 6 614 is selected because the user of device 702 belongs to a loyalty program administered by loyalty program provider 2.

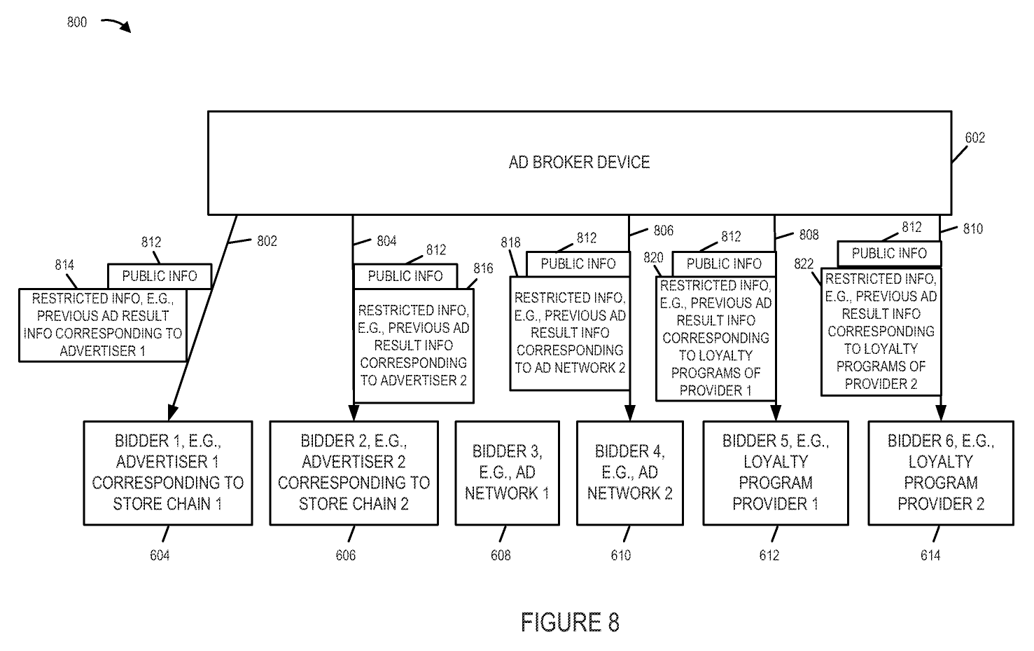

In drawing 800 of FIG. 8 ad broker device 602 sends signal 802 to bidder 1 604. Signal 802 includes general information about the ad cache space being auctioned 706, public information 812 and restricted information 814, e.g., previous ad result information including ad performance information corresponding to advertiser l′s ads which were on mobile device 702. Ad broker device 602 sends signal 804 to bidder 2 606. Signal 804 includes general information about the ad cache space being auctioned 706, public information 812 and restricted information 816, e.g., previous ad result information including ad performance information corresponding to advertiser 2's ads which were on mobile device 702. Ad broker device 602 sends signal 806 to bidder 4 610. Signal 806 includes general information about the ad cache space being auctioned 706, public information 812 and restricted information 818, e.g., previous ad result information including ad performance information corresponding to ad network 2's ads which were on mobile device 702. Ad broker device 602 sends signal 808 to bidder 5 612. Signal 808 includes general information about the ad cache space being auctioned 706, public information 812 and restricted information 820, e.g., previous ad result information including ad performance information corresponding to ads of loyalty programs administered by loyalty program provider 1 which were on mobile device 702. Ad broker device 602 sends signal 810 to bidder 6 614. Signal 810 includes general information about the ad cache space being auctioned 706, public information 812 and restricted information 822, e.g., previous ad result information including ad performance information corresponding to ads of loyalty programs administered by loyalty program provider 2 which were on mobile device 702. In some embodiments, the general information about the ad cache space being auctioned includes: information identifying the size of the space being auctioned, information identifying the number of blocks of ad cache space being including in the auction, information identifying the rules of the auction, e.g., number of winners, distribution of ad cache space between multiple winners in cases where there are multiple winners, information identifying a time duration and/or a time interval in which the bid winner is allowed to have ads stored in the won ad space, information identifying whether or not the winning bidder is allowed to update and/or change an ad in won ad cache space during the time the bid winner is allowed to occupy the ad cache space. In various embodiments, the public information 812 includes some of the information received in the peer to peer broadcast signals conveying expressions. In some embodiments, the public information 812 includes general information identifying a group classification in which the user of device 702 belongs, e.g., age group, financial income bracket, a general interest of the user, a buying pattern, etc., but does not include specific information identifying the particular user.

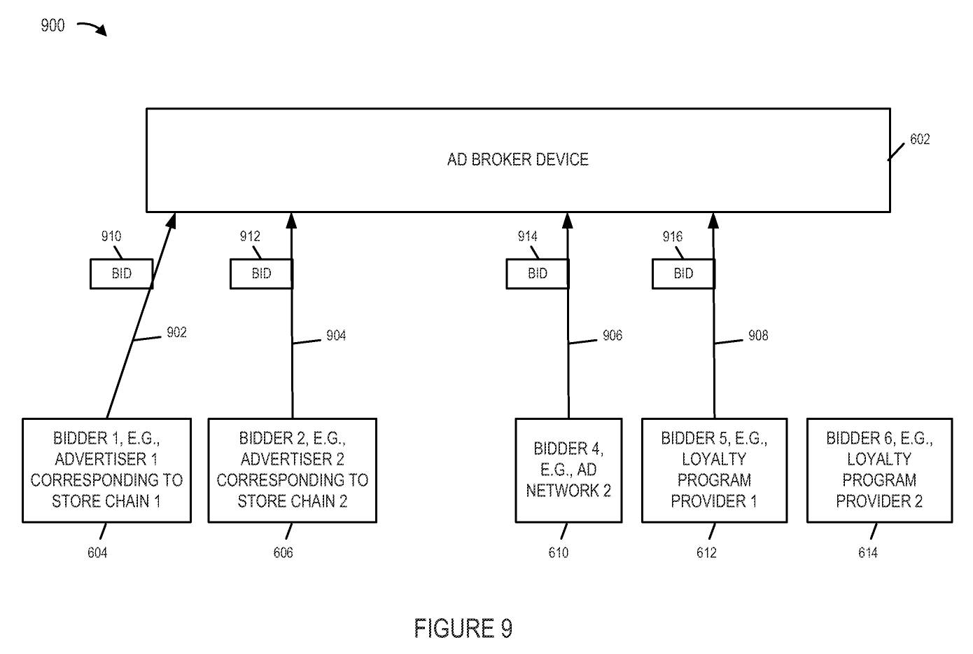

Each of the potential bidders (604, 606, 610, 612, 614) receives the information communicated in signals (802, 804, 806, 808, 810), respectively, and makes a decision whether or not to place a bid for the ad cache space 706 and what value to bid. In drawing 900 of FIG. 9, bidders (bidder 1 604, bidder 2 606, bidder 4 610, bidder 5 612) has decided to place bid. Bidders (bidder 1 604, bidder 2 606, bidder 4 610, bidder 5 612) transmit signals (902, 904, 906, 908) to ad broker device 602 conveying bids (910, 912, 914, 916) respectively.

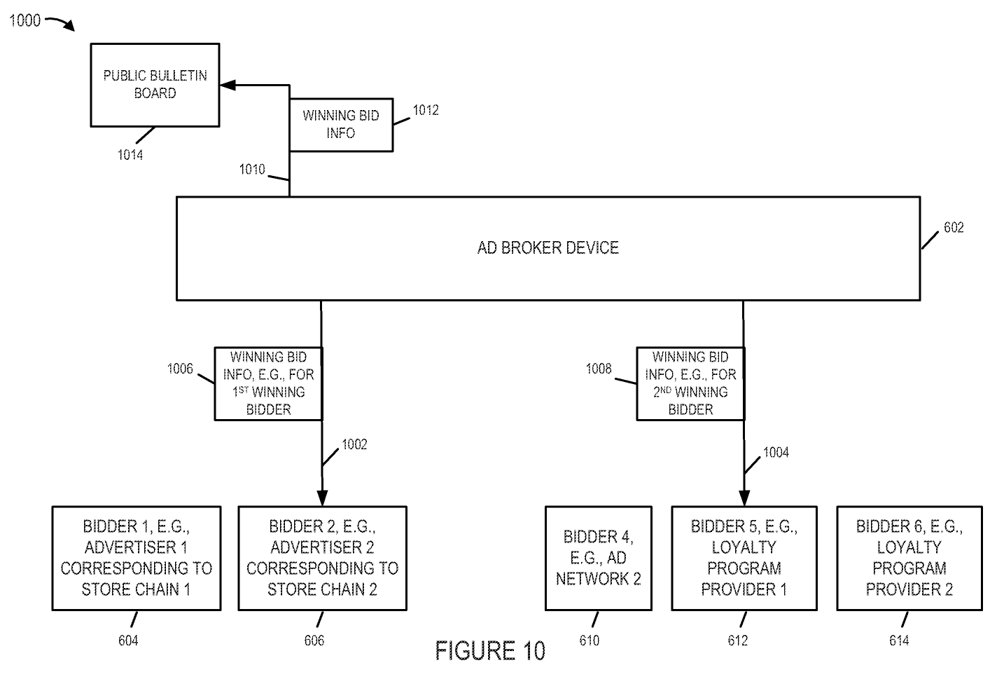

In this example, the bidding rules implemented by ad broker device 602 are that the highest bidder wins 2 blocks of ad cache space 706 and the second highest bidder receives 1 block of ad cache space 706. In Drawing 1000 of FIG. 10, ad broker device 602 processes the received bids and determines that bidder 2 606 is the 1st winning bidder and bidder 5 612 is the 2nd winning bidder. Ad broker device 602 generates and transmits signals (1002, 1004) to bidder devices (606, 612) conveying winning bid information (1006, 1008), respectively. Information 1006 provides information about the ad storage space that has been won and the amount of the winning bid, e.g., information identifying that bidder 2 is the 1st winning bidder, information identifying that bidder 2 has won two blocks in ad cache space 706, information identifying the won ad cache space, access information to load ads in the won ad cache space, the amount of the winning bid, and information to pay for the winning bid. Information 1008 provides information about the ad storage space that has been won and the amount of the winning bid, e.g., information identifying that bidder 5 is the 2nd winning bidder, information identifying that bidder 5 has won one block in ad cache space 706, information identifying the won ad cache space, access information to load ads in the won ad cache space, the amount of the winning bid, and information to pay for the winning bid. Ad broker device 602 also transmits signal 1010 to device 1014 including a public bulletin board on which winning bid information 1012 is posted. In various embodiments winning bid information 1012 is transmitted at a later time than winning bid information (1006, 1008). In various embodiments, winning bid information 1012 is more general than winning bid information (1006, 1008), e.g., information 1012 does not identity the specific winning bidders but does identify the winning bid prices.

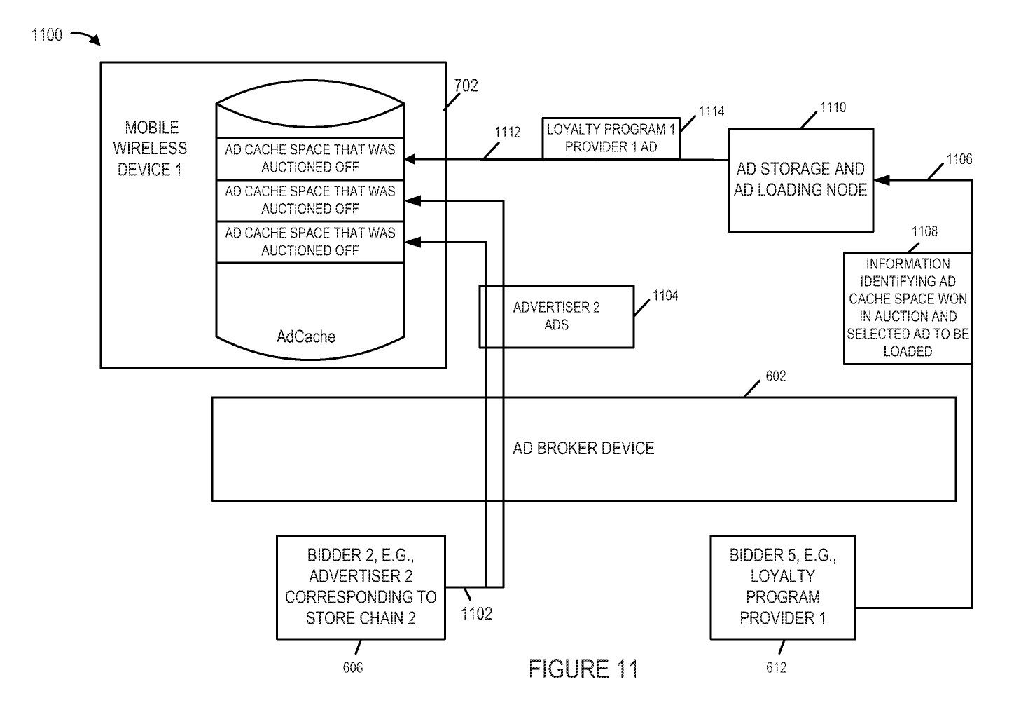

Drawing 1100 of FIG. 11 illustrates exemplary loading of ads into the won ad cache space 706 in ad cache 704 of mobile device 702. Winning bidder 606 loads ads via ad broker device 602 into mobile device 702. Signals 1102 communicate advertiser 2 ads 1104 into the two ad cache space blocks won by bidder 2 604. Winner bidder 612 loads ads into mobile device 1 702 by a signaling route that does not include ad broker device 602. Bidder 5 612 transmits signal 1106 including information 1108 identifying the ad cache space that has been won in the auction and the selected ad to be loaded to ad storage and ad loading node 1110. Ad storage and ad loading node 1110 generates and transmits signal 1112 including the ad from loyalty program provider 1 1114 to mobile wireless device 702. Mobile wireless device 702 receives and stores the communicated ads.

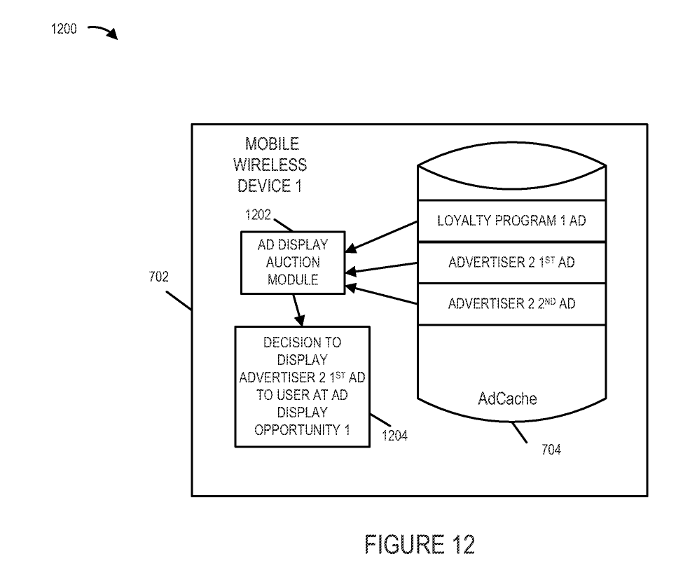

Drawing 1200 of FIG. 12 illustrates that three ads (loyalty program 1 ad, advertiser 2 1st ad, and advertiser 2 2nd ad) have been loaded into the auctioned off ad cache space. Ad display auction module 1202 within mobile device 702 performs an auction for displaying an ad from among the plurality of ads stored in ad cache 704 for each ad display opportunity. In the example of FIG. 12, the auction within device 702 results in the decision to display advertiser 2 1st ad at ad display opportunity 1, and device 1 702 displays the selected ad to the user of device 702. Device 702 also records any response to the ad, e.g., an action indicating a positive response to the ad.

The techniques of various embodiments may be implemented using software, hardware and/or a combination of software and hardware. Various embodiments are directed to apparatus, e.g., ad broker devices which may be mobile or stationary devices, mobile nodes including ad caches such as a mobile terminal including an ad cache, stationary nodes including ad caches such as a fixed location access point including an ad cache, bidder devices such as, e.g., an advertising network device or an advertiser device or a store device, and/or ad broker systems and/or advertising systems. Various embodiments are also directed to methods, e.g., a method of controlling and/or operating ad broker system, an ad broker network and/or an ad broker device, a mobile node including an ad cache, a fixed node including an ad cache, a bidder node, and/or advertising systems. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

In various embodiments nodes described herein are implemented using one or more modules to perform the steps corresponding to one or more methods, for example, signal processing, signal generation and/or transmission steps. Thus, in some embodiments various features are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., communications node, including a processor configured to implement one, multiple or all of the steps of one or more methods of the invention.

In some embodiments, the processor or processors, e.g., CPUs, of one or more devices, e.g., such as an ad broker network device, mobile or stationary device including an ad cache, or bidder device, are configured to perform the steps of the methods described as being performed by the device. The configuration of the processor may be achieved by using one or more modules, e.g., software modules, to control processor configuration and/or by including hardware in the processor, e.g., hardware modules, to perform the recited steps and/or control processor configuration. Accordingly, some but not all embodiments are directed to a device, e.g., communications node, with a processor which includes a module corresponding to each of the steps of the various described methods performed by the device in which the processor is included. In some but not all embodiments a device, e.g., communications node, includes a module corresponding to each of the steps of the various described methods performed by the device in which the processor is included. The modules may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a communications device or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device or other device described in the present application.

Various embodiments are well suited to communications systems using a peer to peer to peer signaling protocol.

While described in the context of an OFDM system, at least some of the methods and apparatus of various embodiments are applicable to a wide range of communications systems including many non-OFDM and/or non-cellular systems.

Numerous additional variations on the methods and apparatus of the various embodiments described above will be apparent to those skilled in the art in view of the above description. Such variations are to be considered within the scope. The methods and apparatus may be, and in various embodiments are, used with CDMA, orthogonal frequency division multiplexing (OFDM), and/or various other types of communications techniques which may be used to provide wireless communications links between communications devices. In some embodiments one or more communications devices are implemented as access points which establish communications links with mobile nodes using OFDM and/or CDMA and/or may provide connectivity to the internet or another network via a wired or wireless communications link. In various embodiments the mobile nodes are implemented as notebook computers, personal data assistants (PDAs), or other portable devices including receiver/transmitter circuits and logic and/or routines, for implementing the methods.

What is claimed is:

1. A method of operating an ad broker system, comprising:
receiving information relevant to ad targeting from at least one device, said device including an ad cache in which ad information may be stored;
providing at least some of said received information to a plurality of competing bidders; and
auctioning off storage space in said ad cache to said plurality of competing bidders.

2. The method of claim 1, further comprising:
providing an individual bidder, who won the opportunity to store ad information in said ad cache, information about the amount of ad storage space that has been won and the amount of the winning bid.

3. The method of claim 1, further comprising:
wherein information received from an individual device includes at least some public information and some restricted information.

4. The method of claim 3, wherein providing at least some received information to a plurality of competing bidders includes:
providing the received public information to each of the competing bidders; and
providing at least some restricted information to one or more of the competing bidders who are authorized to receive the restricted information.

5. The method of claim 4, wherein different competing bidders receive different subsets of the restricted information based on their different rights to access restricted information.

6. The method of claim 5, wherein individual competing bidders are provided with restricted information corresponding to loyalty programs they administer but not loyalty programs which they do not administer.

7. The method of claim 4, wherein said restricted information includes at least some personal user information and where said providing of said restricted information to bidders is controlled as a function of user specified information sharing restrictions.

8. An ad broker device comprising:
means for receiving information relevant to ad targeting from at least one device, said device including an ad cache in which ad information may be stored;
means for providing at least some of said received information to a plurality of competing bidders; and
means for auctioning off storage space in said ad cache to said plurality of competing bidders.

9. The ad broker device of claim 8, further comprising:
means for providing an individual bidder, who won the opportunity to store ad information in said ad cache, information about the amount of ad storage space that has been won and the amount of the winning bid.

10. The ad broker device of claim 8,
wherein information received from an individual device includes at least some public information and some restricted information.

11. The ad broker device of claim 10, wherein said means for providing at least some received information to a plurality of competing bidders includes:
means for providing the received public information to each of the competing bidders; and
means for providing at least some restricted information to one or more of the competing bidders who are authorized to receive the restricted information.

12. The ad broker device of claim 11, wherein different competing bidders receive different subsets of the restricted information based on their different rights to access restricted information.

13. The ad broker device of claim 12, wherein individual competing bidders are provided with restricted information corresponding to loyalty programs they administer but not loyalty programs which they do not administer.

14. The ad broker device of claim 11, wherein said restricted information includes at least some personal user information and where said providing of said restricted information to bidders is controlled as a function of user specified information sharing restrictions.

15. A computer program product for use in an ad broker device, the computer program product comprising:
a non-transitory computer readable medium comprising:
code for causing at least one computer to receive information relevant to ad targeting from at least one device, said device including an ad cache in which ad information may be stored;
code for causing said at least one computer to provide at least some of said received information to a plurality of competing bidders; and
code for causing said at least one computer to auction off storage space in said ad cache to said plurality of competing bidders.

16. An ad broker device comprising:
at least one processor configured to:
receive information relevant to ad targeting from at least one device, said device including an ad cache in which ad information may be stored;
provide at least some of said received information to a plurality of competing bidders; and
auction off storage space in said ad cache to said plurality of competing bidders; and
memory coupled to said at least one processor.

17. The ad broker device of claim 16, wherein said at least one processor is further configured to:
provide an individual bidder, who won the opportunity to store ad information in said ad cache, information about the amount of ad storage space that has been won and the amount of the winning bid.

18. The ad broker device of claim 16,
wherein information received from an individual device includes at least some public information and some restricted information.

19. The ad broker device of claim 18, wherein said at least one processor is configured to:
provide the received public information to each of the competing bidders; and
provide at least some restricted information to one or more of the competing bidders who are authorized to receive the restricted information, as part of being configured to provide at least some received information to a plurality of competing bidders.

20. The ad broker device of claim 19, wherein different competing bidders receive different subsets of the restricted information based on their different rights to access restricted information.
